(19) United States
(12) Patent Application Publication
(10) Pub. No.: US 2026/0125995 A1
(43) Pub. Date: May 7, 2026

(54) VALVETRAIN SYSTEMS FOR CYLINDER DEACTIVATION WITH RECHARGING AND METHODS THEREOF

(71) Applicant: Eaton Intelligent Power Limited, Dublin 4 (IE)

(72) Inventors: Tomas BILEK, Brno (CZ); Alessandro ROSCIOLI, Turin (IT); Vladimír BALHÁREK, Jindrichov (CZ)

(21) Appl. No.: 19/434,617

(22) Filed: Dec. 29, 2025

Related U.S. Application Data
(63) Continuation of application No. PCT/IB2024/058058, filed on Aug. 19, 2024.
(60) Provisional application No. 63/520,540, filed on Aug. 18, 2023.

(51) Int. Cl. F01L 13/00; F01L 1/18; F01L 1/26; F01L 1/46; F02D 13/06; F02D 41/00

(52) U.S. Cl. CPC F01L 13/0005; F01L 1/181; F01L 1/267; F01L 13/0036; F02D 13/06; F02D 41/0087; F01L 2001/186; F01L 2001/467; F01L 2013/001

(57) ABSTRACT

A rocker arm assembly operable in a cylinder deactivation mode includes a valve portion, a drive cam portion, and a recharge cam portion. The valve portion is configured to operatively engage with one or more valves of a cylinder. The drive cam portion comprises a switchable lost motion mechanism that is configured to selectively absorb or transfer motion from a drive cam to the valve portion. The recharge cam portion is configured to be coupled to the valve portion.

### PRIORITY

This application claims the benefit under 35 U.S. C. § 365(c) of International Patent Application No. PCT/IB2024/058058, filed 19 Aug. 2024, which claims the benefit under 35 U.S. C. § 119(e) of U.S. Provisional Ser. No. 63/520,540 , filed 18 Aug. 2023, which is incorporated herein by reference.

### TECHNICAL FIELD

This disclosure generally relates to engine valvetrain systems, and more particularly to valvetrains with switchable rocker arms.

### BACKGROUND

Cylinder deactivation (CDA) in engines can provide benefits such as improved overall efficiencies, fuel economy, and aftertreatment performance at low loads. Valvetrain systems can be adapted to selectively deactivate one or more cylinders in an engine based on preventing motion of the intake and/or exhaust valves of the corresponding cylinders.

However, CDA methodologies based on by shutting off valve motion may incur particular disadvantages for engine performance. For example, a lack of cylinder pressure management authority in CDA mode may be associated with harmful low gas temperatures, lubrication system contamination, and/or reduced emission control. It can therefore be desirable to provide systems and methods for improving cylinder pressure management in CDA mode.

### SUMMARY OF PARTICULAR EMBODIMENTS

The present disclosure relates to features that can enable and improve performance relating to valvetrains with switchable rocker arms. By way of example and not limitation, particular disclosed embodiments describe systems and methods to allow recharging and/or balancing of cylinder pressure for deactivated cylinders in cylinder deactivation (CDA) applications of valvetrains. In particular embodiments, recharging and/or balancing of cylinder pressure can be accomplished by implementing one or more valve opening events for one or more intake and/or exhaust valves of the deactivated cylinder.

In particular embodiments, a rocker arm assembly of a valvetrain operable in a cylinder deactivation mode is disclosed, the rocker arm assembly including: a valve portion configured to operatively engage with one or more valves of a cylinder; a drive cam portion configured to operatively engage with a drive cam associated with a drive cam lift profile, the drive cam portion including a switchable lost motion mechanism configured to selectively absorb motion from the drive cam or transfer motion from the drive cam to the valve portion; and a recharge cam portion configured to be rotatably coupled to the valve portion; wherein when the cylinder deactivation mode is enabled, the switchable lost motion mechanism is configured to absorb motion from the drive cam to deactivate the cylinder, and the recharge cam portion is configured to operatively engage with a recharge cam associated with a recharge valve lift profile and transfer motion from the recharge cam to the valve portion to permit balancing pressure within the deactivated cylinder.

In particular embodiments, which may combine the features of some or all of the above embodiments, a transfer of motion from the drive cam to the valve portion causes one or more of the valves to move. In particular embodiments, which may combine the features of some or all of the above embodiments, a transfer of motion from the drive cam to the valve portion causes one or more of the valves to move according to the drive lift profile associated with the drive cam.

In particular embodiments, which may combine the features of some or all of the above embodiments, the drive valve lift profile includes a plurality of drive valve lift displacements over an engine cycle and the recharge valve lift profile includes a plurality of recharge valve lift displacements over the engine cycle such that each drive valve lift displacement is greater than or equal to each corresponding recharge valve lift displacement over the engine cycle. In particular embodiments, when the cylinder deactivation mode is disabled, the switchable lost motion mechanism transfers motion from the drive cam to the valve portion.

In particular embodiments, which may combine the features of some or all of the above embodiments, when the cylinder deactivation mode is disabled, the recharge cam portion receives motion from the recharge cam corresponding to a base circle valve lift of the recharge cam or the recharge cam portion disengages from the recharge cam for one or more portions of the engine cycle.

In particular embodiments, which may combine the features of some or all of the above embodiments, the switchable lost motion mechanism includes a latch mechanism including a latch bore and one or more latch pins. In particular embodiments, which may combine the features of some or all of the above embodiments, the rocker arm assembly includes a lost motion spring.

In particular embodiments, which may combine the features of some or all of the above embodiments, the one or more latch pins are hydraulically or electrically actuated to selectively decouple the drive cam portion from rotating with the valve portion about a rocker shaft. In particular embodiments, which may combine the features of some or all of the above embodiments, the drive cam portion includes a drive roller configured to receive the drive valve lift profile and the recharge cam portion includes a recharge roller configured to receive the recharge valve lift profile, wherein the latch bore of the latch mechanism is at least partially disposed in the drive roller.

In particular embodiments, which may combine the features of some or all of the above embodiments, the recharge cam portion is rigidly coupled to the valve portion to rotate as an integral unit about a rocker shaft. In particular embodiments, which may combine the features of some or all of the above embodiments, the one or more valves of the cylinder are intake valves. In particular embodiments, which may combine the features of some or all of the above embodiments, the one or more valves of the cylinder are exhaust valves.

In particular embodiments, which may combine the features of some or all of the above embodiments, a method of operating a valvetrain is disclosed including, when a cylinder deactivation mode of the valvetrain is enabled, absorbing, by a switchable lost motion mechanism of a rocker arm assembly of the valvetrain, motion received from a drive cam by a drive cam portion of the rocker arm assembly to deactivate a cylinder associated with the valvetrain, the drive cam associated with a drive cam lift profile; and transferring, by a recharge cam portion of the rocker arm assembly to a valve portion of the rocker arm assembly, motion received from a recharge cam by the recharge cam portion to open one or more valves associated with the cylinder to permit balancing pressure within the deactivated cylinder, the recharge cam associated with a recharge valve lift profile, wherein the switchable lost motion mechanism is configured to selectively absorb motion from the drive cam or transfer motion from the drive cam to the valve portion.

In particular embodiments, which may combine the features of some or all of the above embodiments, the method includes, when the cylinder deactivation mode is disabled, transferring, by the switchable lost motion mechanism, motion from the drive cam to the valve portion of the rocker arm assembly. In particular embodiments, which may combine the features of some or all of the above embodiments, the drive valve lift profile includes a plurality of drive valve lift displacements over an engine cycle and the recharge valve lift profile includes a plurality of recharge valve lift displacements over the engine cycle such that each drive valve lift displacement is greater than or equal to each corresponding recharge valve lift displacement over the engine cycle. In particular embodiments, which may combine the features of some or all of the above embodiments, the method includes, when the cylinder deactivation mode is disabled, receiving, by the recharge cam portion, motion from the recharge cam corresponding to a base circle valve lift of the recharge cam; or disengaging the recharge cam portion from the recharge cam for one or more portions of the engine cycle.

In particular embodiments, which may combine the features of some or all of the above embodiments, a valvetrain system is disclosed including: a cylinder configured to be selectively deactivated; one or more valves associated with the cylinder; a drive cam and a recharge cam associated with the one or more valves; a rocker shaft; a rocker arm assembly configured to be rotatable about the rocker shaft, the rocker arm assembly including: a valve portion configured to operatively engage with the one or more valves; a drive cam portion configured to operatively engage with a drive cam associated with a drive cam lift profile, the drive cam portion including a switchable lost motion mechanism configured to selectively absorb motion from the drive cam or transfer motion from the drive cam to the valve portion; and a recharge cam portion configured to be rotatably coupled to the valve portion; wherein when an cylinder deactivation mode is enabled, the switchable lost motion mechanism is configured to absorb motion from the drive cam to deactivate the cylinder, and the recharge cam portion is configured to operatively engage with a recharge cam associated with a recharge valve lift profile and transfer motion from the recharge cam to the valve portion to permit balancing pressure within the deactivated cylinder.

In particular embodiments, which may combine the features of some or all of the above embodiments, the drive valve lift profile includes a plurality of drive valve lift displacements over an engine cycle and the recharge valve lift profile includes a plurality of recharge valve lift displacements over the engine cycle such that each drive valve lift displacement is greater than or equal to each corresponding recharge valve lift displacement over the engine cycle.

In particular embodiments, which may combine the features of some or all of the above embodiments, when the cylinder deactivation mode is disabled, the switchable lost motion mechanism transfers motion from the drive cam to the valve portion. In particular embodiments, which may combine the features of some or all of the above embodiments, when the cylinder deactivation mode is disabled, the recharge cam portion receives motion from the recharge cam corresponding to a base circle valve lift of the recharge cam or the recharge cam portion disengages from the recharge cam for one or more portions of the engine cycle. In particular embodiments, which may combine the features of some or all of the above embodiments, the switchable lost motion mechanism includes a latch mechanism including a latch bore and one or more latch pins, the valvetrain system further including a lost motion spring.

### BRIEF DESCRIPTION OF THE DRAWINGS

The present invention will be described in greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 illustrates a schematic rear perspective view of an exemplary rocker arm assembly, according to particular embodiments.

FIG. 2 illustrates a schematic front perspective view of an exemplary rocker arm assembly, according to particular embodiments.

FIG. 3 illustrates a schematic sectional rear view of an exemplary rocker arm assembly, according to particular embodiments.

FIGS. 4A-4B illustrate schematic valve lift profiles in drive mode and cylinder deactivation mode respectively, according to particular embodiments.

### DESCRIPTION OF EXAMPLE EMBODIMENTS

The following examples of certain embodiments are provided to facilitate a better understanding of the present disclosure, and are not to be read to limit or define the scope of the disclosure. In accordance with various embodiments of the present disclosure, various mechanisms, assemblies, arrangements, and methods of operation of switchable rocker arm assemblies are disclosed herein.

In particular embodiments, an engine may comprise one or more cylinders, wherein each cylinder may be provided with one or more valves, such as for allowing selective fluid exchange. By way of example and not limitation, an engine cylinder may comprise one or more intake valves, and/or one or more exhaust valves. In particular embodiments, the valvetrain of an engine may include devices and systems configured to operate one or more valves of a cylinder. By way of example and not limitation, valve operation parameters such as determination of whether one or more particular valves lift (i.e., open) during operation, an extent of such lift, and/or a timing of such lift relative to other indices of engine operation, such as cylinder motion, may be based on thermodynamic considerations and/or desired modes of operation. By way of example and not limitation, it may be desirable for a valve of an engine cylinder to be opened during particular times during engine operation, and closed during other times. By way of example and not limitation, it can be common practice to reference valve timing relative to one or more other indices of engine operation, such as a position or periodic phase of cylinder motion, crankshaft rotation, and/or camshaft rotation. By way of example and not limitation, valve opening may be referenced in terms of an extent of valve lift, such as a height or displacement of valve opening relative to a seated closed position of a valve. By way of example and not limitation, valve lift may be referenced against a suitable periodic phase to convey detailed information about valve timing and/or operation. In particular embodiments, a valve lift profile may comprise time-varying information about valve operation. By way of example and not limitation, a valve lift profile may comprise an extent and/or a sequence of valve lifts and/or valve opening displacements over time, for e.g., associated with one or more portions of an engine cycle. In particular embodiments, a rocker arm assembly receiving motion from a cam may correspond to the rocker arm assembly receiving one or more portions of a valve lift profile associated with the cam.

In particular embodiments, a valvetrain may comprise valve timing devices and/or systems configured to impart and/or modify valve timing. By way of example and not limitation, valve timing systems may comprise mechanical means, such as one or more camshafts configured to rotate based on engine operation, such as indexed to periodic cylinder motion. By way of example and not limitation, a camshaft may comprise one or more cams configured to provide a geometric representation of a desired extent of valve lift for opening one or more valves of interest based on rotation of a corresponding camshaft. By way of example and not limitation, a cam may include one or more lobes rising above a minimum characteristic dimension, e.g., a base circle, to encode a physical manifestation of a desired time-varying evolution of valve lift displacements comprising a valve lift profile, which may be transferred to a suitable interfacing component via rotation of the cam. In particular embodiments, devices and systems for imparting and/or modifying valve timing may not be cam-based in one or more respects. In particular embodiments, valves may be directly or indirectly operated using actuators with or without employing cams. By way of example and not limitation, hydraulic, electromagnetic, and/or pneumatic actuators may be configured to directly or indirectly operate one or more valves.

In particular embodiments, a rocker arm assembly of a valvetrain may be configured to receive, transmit, modify, and/or selectively transfer one or more valve lift profiles.

In particular embodiments, receiving of a valve lift profile by a rocker arm assembly may comprise transfer of a force or motion from a suitable mechanism such as described above, for e.g., a cam, or an electromagnetic actuator. By way of example and not limitation, a received motion associated with receiving a valve lift profile may comprise displacements, translational motion, and/or rotational motion. By way of example and not limitation, receiving of a valve lift profile may comprise receiving no force or motion for some or all portions of an engine cycle, for e.g., due to partial or total loss of contact of a roller with a cam, and/or due to a mode change by design.

In particular embodiments, a rocker arm assembly may be configured to directly or indirectly receive one or more valve lift profiles. By way of example and not limitation, a rocker arm assembly may be configured to directly receive a valve lift profile from a cam via a suitable mechanism, e.g., based on a time-varying or permanent rotational engagement with a roller mechanism. By way of example and not limitation, a rocker arm assembly may be configured to indirectly receive a valve lift profile from a cam via a suitable mechanism, e.g., a pushrod mechanism. In particular embodiments, a force or motion transfer path between a cam and a rocker arm assembly associated with receiving a valve lift profile may additionally or alternatively comprise one or more intermediate components, e.g., a lash adjustment mechanism.

In particular embodiments, transmitting of a valve lift profile by a rocker arm assembly may comprise conversion of a force or motion associated with a received valve lift profile to a corresponding force or motion applied at a valve-interfacing portion of the rocker arm assembly. By way of example and not limitation, a rocker arm assembly configured to receive motion corresponding to a valve lift profile received from a cam via a roller mechanism may rotate about a rocker shaft and via such rotation, may transmit the received valve lift profile as a corresponding motion applied by an extended structure at a valve end as a valve lift to one or more valves.

As will be further described herein, in particular embodiments, a rocker arm assembly may modify and/or selectively transfer a valve lift profile. By way of example and not limitation, a rocker arm assembly may be configured to selectively absorb or transmit some or all parts of a received valve lift profile. By way of example and not limitation, a rocker arm assembly may be configured to selectively combine more than one received valve lift profile.

In particular embodiments, when a cylinder deactivation (CDA) mode is enabled in engine operation, gas trapped inside a cylinder may consume work and/or dissipate energy. By way of example and not limitation, trapped gas in CDA applications may drive or incur blow-by of trapped gas into a crankcase, undesirable heat transfer, and/or may lead to gas energy dissipation resulting in pressure decays and gas temperature drop. In particular embodiments, a negative pressure gradient from cylinder relative to the crankcase may lead to unwanted oil leak into combustion chamber. Separately or additionally, in particular embodiments, low gas temperature may be harmful to engine operation in terms of emissions, and in extreme cases, may be associated with formation of crystals from vapors inside cylinder. In particular embodiments, one or more of such phenomena may be more pronounced when CDA vacuum strategies are applied, such as by deactivating intake valves before deactivating exhaust valves. Accordingly, in particular embodiments, design for application of CDA recharging can therefore be beneficial, such as by providing relatively small valve opening event(s) during CDA enabled mode. By way of example and not limitation, CDA recharging may provide pressure balancing and/or rebalancing during engine operation with CDA mode enabled.

In particular embodiments, a valvetrain system comprising a rocker arm assembly may allow implementation of CDA recharging strategies, such as those described above by way of non-limiting example. While this disclosure may describe particular kinds of valvetrain architectures and/or switchable rocker arm designs to provide a better understanding, it will be appreciated that this disclosure contemplates any suitable valvetrain architecture and/or switchable rocker arm design for implementing CDA recharging strategies. By way of example and not limitation, systems and methods described herein may be adapted to any suitable valvetrain architecture, such as Types I through V, and any such variations are fully contemplated herein in any suitable combination.

Systems and methods described herein may be adapted to many kinds of switching mechanisms and/or actuation methods for implementing switchable rocker arm systems and/or switchable lost motion mechanisms. In particular embodiments, hydraulically driven actuation systems described herein by way of non-limiting example may be complemented or replaced by electrically or electromagnetically driven actuation systems, such as using solenoids. In particular embodiments, valve lift profiles may be directly transferred to a rocker arm assembly from a cam, such as via a roller mechanism. In particular embodiments, valve lift profiles may be indirectly transferred to a rocker arm assembly, such as via a pushrod mechanism, and/or via a hydraulic lash adjuster or other mechanism.

By way of example and not limitation, collapsible and/or extendable systems, capsule based systems, and/or other lost motion mechanisms with or without springs may employed in particular embodiments. By way of example and not limitation, latch mechanisms comprising one or more pins may be employed. In particular embodiments, one or more pins of the latch mechanism employed herein may be respectively biased along one or more directions.

By way of example and not limitation, systems and methods described herein may be adapted to applications that may not be limited to cylinder deactivation (CDA) systems and/or recharging thereof. By way of example and not limitation, systems and methods described herein may be adapted to other applications provided or enabled by switchable valvetrains, such as variable valve timing applications and/or engine braking applications, and such variations are fully contemplated herein in any suitable combination. While particular examples are included above for providing the features, functions, and/or supporting the applications disclosed herein, it will be appreciated that any other suitable methods, systems, applications, and combinations thereof are fully contemplated in this disclosure.

In particular embodiments, systems and methods of switchable and/or deactivating rocker arm assemblies are disclosed that may allow opening of one or more valve(s) for recharging when a cylinder deactivation (CDA) mode is enabled, such as in internal combustion engines. In particular embodiments, one or more valves operable for CDA recharging may be intake valves, or exhaust valves, or a combination thereof. In particular embodiments, as will be further described herein, when an operational mode such as a drive mode is enabled that comprises disablement of cylinder deactivation, a standard or drive valve lift may be translated by a rocker arm assembly from a drive cam to one or more valves for providing a drive mode operation without cylinder activation. In contrast, in particular embodiments, when a CDA mode is enabled, the standard or drive valve event may be eliminated, and instead a recharging valve lift may be translated by the rocker arm assembly from a recharge cam to one or more valves for providing a cylinder activation mode with recharging.

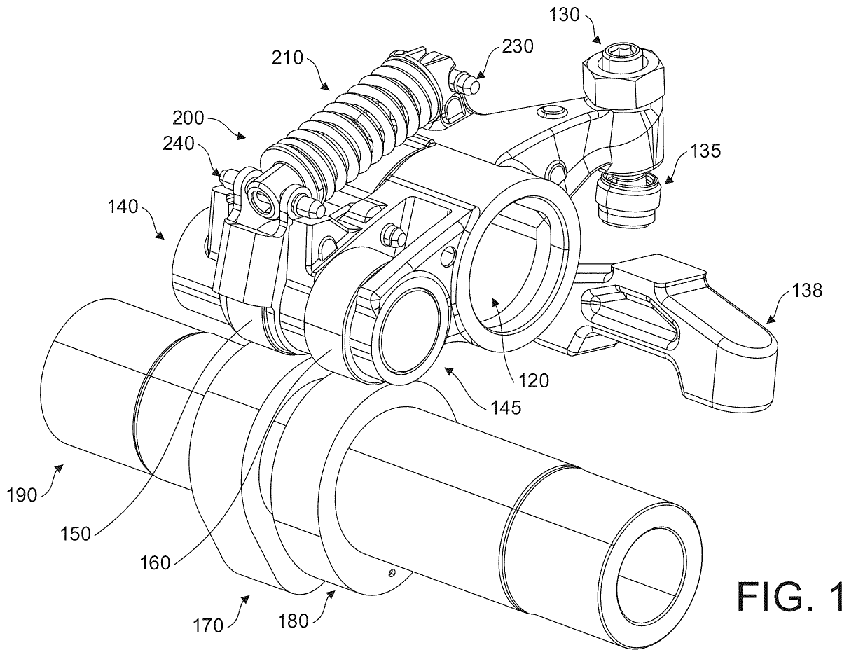

With reference to the figures, FIG. 1 illustrates a schematic rear perspective view of an exemplary rocker arm assembly, according to particular embodiments. In particular embodiments, a rocker arm assembly 110 may be configured to rotate about a rocker shaft passing through a rocker shaft bore 120. In particular embodiments, rocker arm assembly 110 may comprise a first rocker arm portion comprising a valve portion 130 configured to operatively engage with one or more valves of a cylinder. In particular embodiments, valve portion 130 may comprise one or more extended structures, such as to respectively engage one or more valves. By way of example and not limitation, an extended structure of valve portion 130 may comprise a suitable interfacing structure for directly or indirectly engaging a valve, such as via E-foot 135. In particular embodiments, one or more portions of valve portion 130 may engage a plurality of valves, such as via valve bridge 138. In particular embodiments, valve portion 130 may comprise one or more switchable assemblies, such as a collapsible and/or extendable capsule assembly.

In particular embodiments, rocker arm assembly 110 may comprise a second rocker arm portion configured to receive one or more valve lift profiles, such as directly or indirectly from one or more cams. In particular embodiments, the second rocker arm portion may comprise a first cam portion, such as drive cam portion 140. In particular embodiments, drive cam portion 140 may comprise a roller mechanism, such as drive roller 150, configured to be directly engageable with a cam, such as drive cam 170. In particular embodiments, the second rocker arm portion may separately or additionally comprise a second cam portion, such as recharge cam portion 145. In particular embodiments, recharge cam portion 145 may comprise a roller mechanism, such as recharge roller 160, configured to be directly engageable with a cam, such as recharge cam 180. In particular embodiments, drive cam 170 and recharge cam 180 may be provided on the same camshaft, such as camshaft 190 illustrated in FIG. 1 by way of example and not limitation. In particular embodiments, separate cams configured to interface with rocker arm assembly 110 may be disposed on separate camshafts. In particular embodiments, recharge cam portion 145 may be rigidly coupled to the valve portion 130 such that they rotate as an integral unit about a rocker shaft of the valvetrain.

In particular embodiments, a switchable cam portion of rocker arm assembly 110 such as drive cam portion 140 may be axially enclosed and/or supported by a forked portion of rocker arm assembly 110. By way of example and not limitation, enclosing both sides of drive cam portion 140 to be axially supported within a forked section of rocker arm assembly 110 may reduce side-to-side force asymmetries, twist, wobble, and/or latching inconsistencies, and/or may help control uneven wear over time. In particular embodiments, such a design can also reduce the overall material and cross-section needed to sustain operational loads, leading to less costly and/or lighter parts.

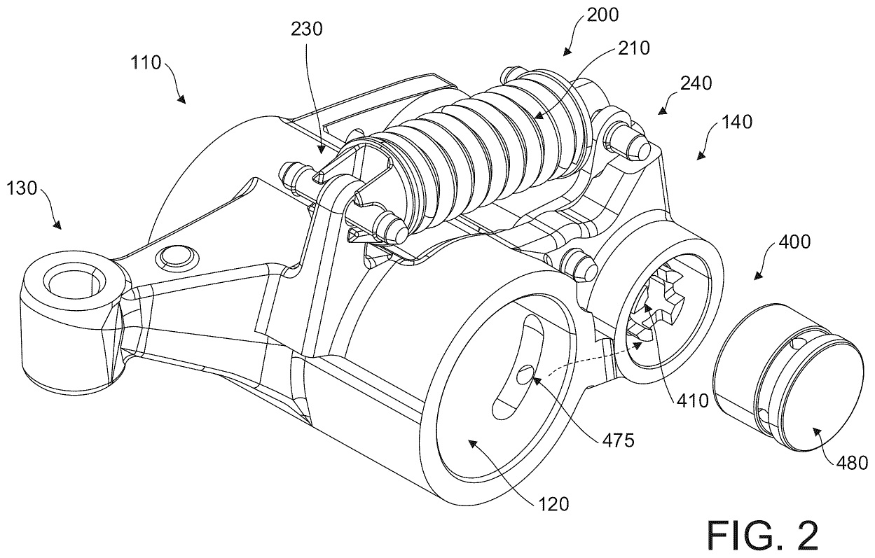

FIG. 2 illustrates a schematic front perspective view of an exemplary rocker arm assembly, according to particular embodiments.

In particular embodiments, rocker arm assembly 110 may comprise one or more switchable mechanisms. In particular embodiments, one or more switchable mechanisms of rocker arm assembly 110 may be configured to selectively transmit, modify, and/or absorb one or more portions of one or more valve lift profiles received by rocker arm assembly 110. By way of example and not limitation, drive cam portion 140 of rocker arm assembly 110 may comprise a switchable lost motion mechanism. In particular embodiments, a switchable lost motion mechanism of rocker arm assembly 110 may comprise a lost motion mechanism 200. In particular embodiments, a switchable lost motion mechanism of rocker arm assembly 110 may comprise a switchable latch assembly 400. In particular embodiments, latch assembly 400 may be hydraulically actuated, such as based on receiving a pressurized hydraulic fluid. Separately or additionally, in particular embodiments, latch assembly 400 may be electrically or electromagnetically actuated, such as by a solenoid.

In particular embodiments, lost motion mechanism 200 may comprise one or more systems configured for absorbing displacement and/or motion. By way of example and not limitation, lost motion mechanism 200 may comprise a lost motion spring 210 capable of absorbing valve lift received from drive cam 170, such as by compressing based on receiving force, displacement, and/or energy associated with a valve lift from a cam. In particular embodiments, lost motion spring 210 may be supported by an optional lost motion support member 220.

In particular embodiments, lost motion mechanism 200 may be secured to and/or supported by one or more connection assemblies connected to other portions of rocker arm assembly 110. In particular embodiments, a first connection 230 may operably couple lost motion mechanism 200 to a suitable portion of rocker arm assembly 110, such as to valve portion 130 or to first rocker arm portion of rocker arm assembly 110. In particular embodiments, a second connection 240 may operably couple lost motion mechanism 200 to drive cam portion 140. By way of example and not limitation, first connection 230 and/or second connection 240 may comprise one or more pivotable couplings to pivotably couple respective structures, such as described and/or illustrated herein. In particular embodiments, first connection 230 and/or second connection 240 may comprise one or more slots, anchors, or other suitable means for coupling drive cam portion 140 and/or a switchable mechanism such as lost motion mechanism 200 with one or more remaining portions of rocker arm assembly 110.

As discussed previously, while particular features of specific lost motion mechanisms (e.g., lost motion mechanism 200) are described and/or illustrated herein to provide a better understanding, other suitable forms and features of switchable mechanisms are fully contemplated in this disclosure. By way of example and not limitation, a switchable assembly to selectively enable or disable operation of lost motion mechanism 200 may be disposed in and/or combined with lost motion mechanism 200 in particular embodiments.

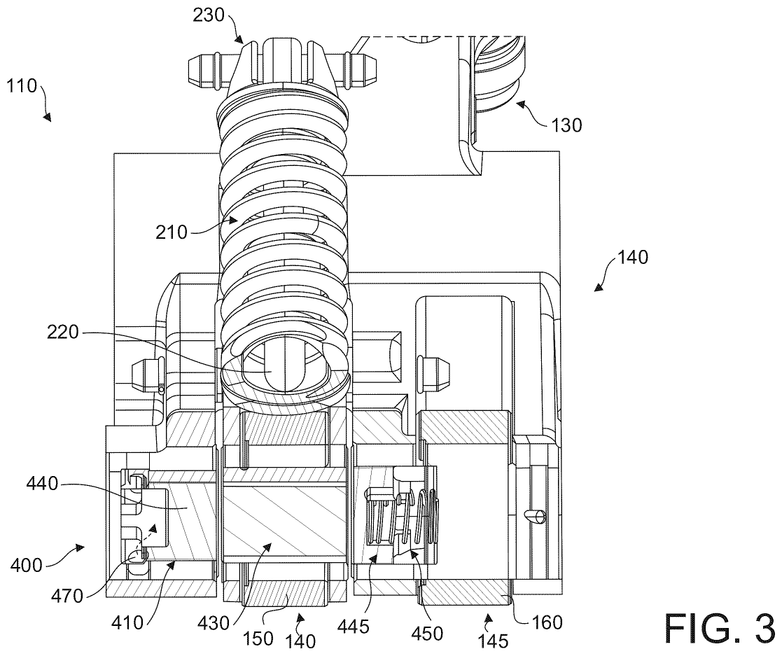

FIG. 3 illustrates a schematic sectional rear view of an exemplary rocker arm assembly, according to particular embodiments. In particular embodiments, latch assembly 400 may be configured to selectively couple drive cam portion 140 to transmit a drive valve lift profile received from drive cam 170 to valve portion 130, and/or so that drive cam portion 140 may rotate integral with the remaining rocker arm assembly 110 about a rocker shaft. In particular embodiments, accordingly, latch assembly 400 may be configured to decouple drive cam portion 140 such that, for example, lost motion mechanism 200 may absorb a drive valve lift profile received by drive cam portion 140 from drive cam 170 and/or otherwise prevent transmitting the received drive valve lift to valve portion 130 of rocker arm assembly 110.

In particular embodiments, latch assembly 400 may comprise a latch bore 410. In particular embodiments, latch bore 410 may comprise a plurality of bore portions disposed across multiple portions of rocker arm assembly 110. In particular embodiments, latch bore 410 may be at least partially disposed in drive roller 150 of drive cam portion 140.

In particular embodiments, one or more latch pins of latch assembly 400 may be configured to be latchable or unlatchable to selectively transmit a drive valve lift profile received from drive cam 170 to valve portion 130 of rocker arm assembly 110. In particular embodiments, one or more latch pins, such as latch pin 430, may be slidably disposed in latch bore 410 such that axial motion along the latch bore 410 may rotatably couple or decouple drive cam portion 140 to rotate relative to valve portion 130, for example, about a rocker shaft disposed in rocker shaft bore 120. In particular embodiments, to enable selective latching by latch assembly 400, one or more latch pins may be configured to selectively slide into, protrude into, and/or out of a portion of latch bore 410 disposed in drive cam portion 140. In particular embodiments, one or more axial ends of latch bore 410 may comprise a biasing mechanism, such as biasing member 450. By way of example and not limitation, a biasing mechanism may comprise one or more springs. In particular embodiments, a biasing mechanism may separately or additionally comprise one or more optional force transfer and/or support members, such as support pin 445.

In particular embodiments, switchable latch assembly 400 may be actuated from one side of one or more slidable members, or from a plurality of sides. In particular embodiments, actuation may be based on differential action based on relative forces applied from a plurality of sides. By way of example and not limitation, FIG. 3 illustrates a piston 440 that is axially movable to the right (in the frame of reference of the figure) when actuated or energized, and/or that is axially restored to the left when de-actuated or de-energized based on a restoring force applied by biasing member 450. In particular embodiments, piston 440 may be selectively movable or translatable based on selectively pressurizing a chamber, such as with hydraulic fluid fed through hydraulic bore 470. In particular embodiments, such as illustrated in FIG. 2 with hydraulic chamber end cap 480 removed, hydraulic bore 470 may be fluidly connected to a controllable pressurized hydraulic fluid source via a hydraulic channel 475. By way of example and not limitation, a solenoid-based oil control valve (OCV) may be used to selectively pressurize a hydraulic line to latch assembly 400, such as via rocker shaft bore 120.

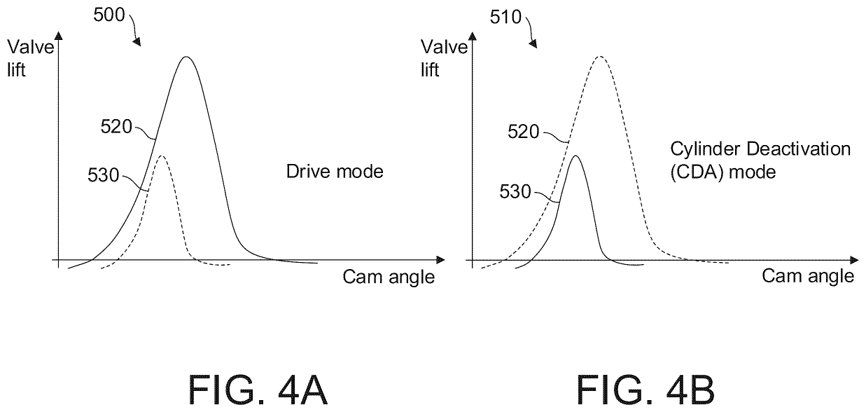

FIGS. 4A-4B illustrate schematic valve lift profiles in drive mode and cylinder deactivation mode respectively, according to particular embodiments. By way of example and not limitation, a drive valve lift profile 520 comprises a plurality of drive valve lifts (or lift displacements) received through a sequence of cam angles over an engine cycle, and a recharge valve lift profile 530 comprises a plurality of recharge valve lifts (or lift displacements) received through a corresponding sequence of cam angles over the engine cycle. In particular embodiments, such as depicted in FIGS. 4A-4B by way of non-limiting example, each drive valve lift received from drive cam 170 by drive cam portion 140 is greater than or equal to each corresponding recharge valve lift at the same cam angle provided by recharge cam 180 throughout the engine cycle.

FIG. 4A illustrates a plot 500 depicting schematic valve lift profiles in a drive mode of the valvetrain, such as when cylinder deactivation (CDA) is disabled, according to particular embodiments. In particular embodiments, such as previously described herein, a standard or drive valve lift profile 520 received by drive cam portion 140 from drive cam 170 is transmitted in this mode to valve portion 130, for example, based on disabling lost motion mechanism 200 by switching latch assembly 400 to rotationally couple drive cam portion 140 to transmit drive valve lift profile 520 to valve portion 130. By way of example and not limitation, such as for embodiments wherein each drive valve lift of drive valve lift profile 520 is greater than or equal to each corresponding recharge valve lift of recharge valve lift profile 530 at the same cam angle, recharge valve lift profile 530 due to recharge cam 180 may be entirely “hidden” in this drive mode. Accordingly, in particular embodiments in a drive mode, recharge cam portion 145 may receive either a base circle valve lift from recharge cam 180, or may disengage from recharge cam 180 during one or more portions of the engine cycle, such as due to a larger displacement received from drive cam 170 transmitted to valve portion 130.

FIG. 4B illustrates a plot 510 depicting schematic valve lift profiles when a cylinder deactivation mode of the valvetrain is enabled, according to particular embodiments. In particular embodiments, such as previously described herein, a standard or drive valve lift profile 520 received by drive cam portion 140 from drive cam 170 is absorbed by lost motion mechanism 200 in this mode, for example, based on engaging lost motion mechanism 200 by switching latch assembly 400 to rotationally decouple drive cam portion 140 from transmitting drive valve lift profile 520 to valve portion 130. In particular embodiments, such as depicted in FIG. 4B by way of non-limiting example, recharge valve lift profile 530 received from recharge cam 180 via recharge cam portion 145 may be transmitted to valve portion 130 to permit opening one or more valves associated with valve portion 130 for recharging and/or balancing pressure within the deactivated cylinder. Accordingly, benefits of avoiding the disadvantages of negative or positive pressure within a deactivated cylinder in CDA mode may be realized.

It will be appreciated that the form(s) of drive valve lift profile 520 and/or recharge valve lift profile 530 depicted in FIGS. 4A-4B are non-limiting and schematic, and are included for providing a better understanding. By way of example and not limitation, either or both of drive valve lift profile 520 or recharge valve lift profile 530 may comprise different shapes (e.g., having multiple peaks), and/or may be positioned differently along the valve lift and/or cam angle axes. Such and other variations are fully contemplated by this disclosure.

### Clauses

Clause 1. A rocker arm assembly of a valvetrain operable in a cylinder deactivation mode, the rocker arm assembly comprising: a valve portion configured to operatively engage with one or more valves of a cylinder; a drive cam portion configured to operatively engage with a drive cam associated with a drive cam lift profile, the drive cam portion comprising a switchable lost motion mechanism configured to selectively absorb motion from the drive cam or transfer motion from the drive cam to the valve portion; and a recharge cam portion configured to be rotatably coupled to the valve portion; wherein when the cylinder deactivation mode is enabled, the switchable lost motion mechanism is configured to absorb motion from the drive cam to deactivate the cylinder, and the recharge cam portion is configured to operatively engage with a recharge cam associated with a recharge valve lift profile and transfer motion from the recharge cam to the valve portion to permit balancing pressure within the deactivated cylinder.

Clause 2. The rocker arm assembly of clause 1, wherein a transfer of motion from the drive cam to the valve portion causes one or more of the valves to move.

Clause 3. The rocker arm assembly as in clauses 1 or 2, wherein a transfer of motion from the drive cam to the valve portion causes one or more of the valves to move according to the drive lift profile associated with the drive cam.

Clause 4. The rocker arm assembly as in any of clauses 1-3, wherein the drive valve lift profile comprises a plurality of drive valve lift displacements over an engine cycle and the recharge valve lift profile comprises a plurality of recharge valve lift displacements over the engine cycle such that each drive valve lift displacement is greater than or equal to each corresponding recharge valve lift displacement over the engine cycle.

Clause 5. The rocker arm assembly as in any of clauses 1-4, wherein when the cylinder deactivation mode is disabled, the switchable lost motion mechanism transfers motion from the drive cam to the valve portion.

Clause 6. The rocker arm assembly of clause 5, wherein when the cylinder deactivation mode is disabled, the recharge cam portion receives motion from the recharge cam corresponding to a base circle valve lift or the recharge cam portion disengages from the recharge cam for one or more portions of the engine cycle.

Clause 7. The rocker arm assembly of clause 1, wherein the switchable lost motion mechanism comprises a latch mechanism comprising a latch bore and one or more latch pins.

Clause 8. The rocker arm assembly of clause 7, further comprising a lost motion spring.

Clause 9. The rocker arm assembly of clause 7, wherein the one or more latch pins are hydraulically or electrically actuated to selectively decouple the drive cam portion from rotating with the valve portion about a rocker shaft.

Clause 10. The rocker arm assembly of clause 7, wherein the drive cam portion comprises a drive roller configured to receive the drive valve lift profile and the recharge cam portion comprises a recharge roller configured to receive the recharge valve lift profile, wherein the latch bore of the latch mechanism is at least partially disposed in the drive roller.

Clause 11. The rocker arm assembly as in any of clauses 1-3, wherein the recharge cam portion is rigidly coupled to the valve portion to rotate as an integral unit about a rocker shaft.

Clause 12. The rocker arm assembly as in any of clauses 1-3, wherein the one or more valves of the cylinder are intake valves.

Clause 13. The rocker arm assembly as in any of clauses 1-3, wherein the one or more valves of the cylinder are exhaust valves.

Clause 14. A method of operating a valvetrain comprising, when a cylinder deactivation mode of the valvetrain is enabled, absorbing, by a switchable lost motion mechanism of a rocker arm assembly of the valvetrain, motion received from a drive cam by a drive cam portion of the rocker arm assembly to deactivate a cylinder associated with the valvetrain, the drive cam associated with a drive cam lift profile; and transferring, by a recharge cam portion of the rocker arm assembly to a valve portion of the rocker arm assembly, motion received from a recharge cam by the recharge cam portion to open one or more valves associated with the cylinder to permit balancing pressure within the deactivated cylinder, the recharge cam associated with a recharge valve lift profile, wherein the switchable lost motion mechanism is configured to selectively absorb motion from the drive cam or transfer motion from the drive cam to the valve portion.

Clause 15. The method of clause 14, further comprising, when the cylinder deactivation mode is disabled, transferring, by the switchable lost motion mechanism, motion from the drive cam to the valve portion of the rocker arm assembly.

Clause 16. The method of clause 15, further wherein the drive valve lift profile comprises a plurality of drive valve lift displacements over an engine cycle and the recharge valve lift profile comprises a plurality of recharge valve lift displacements over the engine cycle such that each drive valve lift displacement is greater than or equal to each corresponding recharge valve lift displacement over the engine cycle.

Clause 17. The method of clause 16, further comprising, when the cylinder deactivation mode is disabled, receiving, by the recharge cam portion, motion from the recharge cam corresponding to a base circle valve lift; or disengaging the recharge cam portion from the recharge cam for one or more portions of the engine cycle.

Clause 18. A valvetrain system comprising: a cylinder configured to be selectively deactivated; one or more valves associated with the cylinder; a drive cam and a recharge cam associated with the one or more valves; a rocker shaft; a rocker arm assembly configured to be rotatable about the rocker shaft, the rocker arm assembly comprising: a valve portion configured to operatively engage with the one or more valves; a drive cam portion configured to operatively engage with a drive cam associated with a drive cam lift profile, the drive cam portion comprising a switchable lost motion mechanism configured to selectively absorb motion from the drive cam or transfer motion from the drive cam to the valve portion; and a recharge cam portion configured to be rotatably coupled to the valve portion; wherein when an cylinder deactivation mode is enabled, the switchable lost motion mechanism is configured to absorb motion from the drive cam to deactivate the cylinder, and the recharge cam portion is configured to operatively engage with a recharge cam associated with a recharge valve lift profile and transfer motion from the recharge cam to the valve portion to permit balancing pressure within the deactivated cylinder.

Clause 19. The valvetrain system of clause 18, wherein the drive valve lift profile comprises a plurality of drive valve lift displacements over an engine cycle and the recharge valve lift profile comprises a plurality of recharge valve lift displacements over the engine cycle such that each drive valve lift displacement is greater than or equal to each corresponding recharge valve lift displacement over the engine cycle.

Clause 20. The valvetrain system of clause 19, wherein when the cylinder deactivation mode is disabled, the switchable lost motion mechanism transfers motion from the drive cam to the valve portion.

Clause 21. The valvetrain system of clause 20, wherein when the cylinder deactivation mode is disabled, the recharge cam portion receives motion from the recharge cam corresponding to a base circle valve lift or the recharge cam portion disengages from the recharge cam for one or more portions of the engine cycle.

Clause 22. The valvetrain system as in any of clauses 18-21, wherein the switchable lost motion mechanism comprises a latch mechanism comprising a latch bore and one or more latch pins, the valvetrain system further comprising a lost motion spring.

### Miscellaneous

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. For example, it is possible that each of the characteristics described in one of the examples of an embodiment can be combined with one or a plurality of other desired characteristics from other embodiments, resulting in other embodiments that may not be described in words or by reference to the drawings, but which are fully contemplated. It will also be understood that changes and modifications may be made by those of ordinary skill within the scope of the disclosure, illustrations, and/or the following claims. Such variations are fully contemplated herein and not to be regarded as a departure from the disclosure, and all such modifications are intended to be included within the scope of the disclosure.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

It should be noted that figures provided herein may be illustrated schematically rather than literally or precisely; components and aspects of the figures may not necessarily be to scale. Moreover, while like reference labels or numerals may designate corresponding parts throughout the different views in many cases, like parts may not always be provided with like reference numerals or labels in each view. Further, like parts may not be labeled in every view or figure. Numerical ranges recited in this application should be construed to be inclusive of the end points of the stated ranges. Particular axes, such as one or more rotational, lateral and/or longitudinal axes, which may be omitted herein in some illustrations, should be construed to exist in every illustration or situation where it is referred to, or to which it reasonably corresponds. Directional descriptors or references, such as “top,” “bottom,” “upper,” “lower,” “left,” or “right,” among others, are provided herein for ease of reference and are not limiting of the embodiments disclosed herein, whether in isolation or when assembled or installed.

1. A rocker arm assembly of a valvetrain operable in a cylinder deactivation mode, the rocker arm assembly comprising:
a valve portion configured to operatively engage with one or more valves of a cylinder;
a drive cam portion configured to operatively engage with a drive cam associated with a drive cam lift profile, the drive cam portion comprising a switchable lost motion mechanism configured to selectively absorb motion from the drive cam or transfer motion from the drive cam to the valve portion; and
a recharge cam portion configured to be rotatably coupled to the valve portion;
wherein when the cylinder deactivation mode is enabled,
the switchable lost motion mechanism is configured to absorb motion from the drive cam to deactivate the cylinder, and
the recharge cam portion is configured to operatively engage with a recharge cam associated with a recharge valve lift profile and transfer motion from the recharge cam to the valve portion to permit balancing pressure within the deactivated cylinder.

2. The rocker arm assembly of claim 1, wherein a transfer of motion from the drive cam to the valve portion causes one or more of the valves to move.

3. The rocker arm assembly of claim 1, wherein a transfer of motion from the drive cam to the valve portion causes one or more of the valves to move according to the drive lift profile associated with the drive cam.

4. The rocker arm assembly of claim 1, wherein the drive valve lift profile comprises a plurality of drive valve lift displacements over an engine cycle and the recharge valve lift profile comprises a plurality of recharge valve lift displacements over the engine cycle such that each drive valve lift displacement is greater than or equal to each corresponding recharge valve lift displacement over the engine cycle.

5. The rocker arm assembly of claim 1, wherein when the cylinder deactivation mode is disabled, the switchable lost motion mechanism transfers motion from the drive cam to the valve portion.

6. The rocker arm assembly of claim 5, wherein when the cylinder deactivation mode is disabled, the recharge cam portion receives motion from the recharge cam corresponding to a base circle valve lift of the recharge cam or the recharge cam portion disengages from the recharge cam for one or more portions of the engine cycle.

7. The rocker arm assembly of claim 1, wherein the switchable lost motion mechanism comprises a latch mechanism comprising a latch bore and one or more latch pins.

8. The rocker arm assembly of claim 7, further comprising a lost motion spring.

9. The rocker arm assembly of claim 7, wherein the one or more latch pins are hydraulically or electrically actuated to selectively decouple the drive cam portion from rotating with the valve portion about a rocker shaft.

10. The rocker arm assembly of claim 7, wherein the drive cam portion comprises a drive roller configured to receive the drive valve lift profile and the recharge cam portion comprises a recharge roller configured to receive the recharge valve lift profile, wherein the latch bore of the latch mechanism is at least partially disposed in the drive roller.

11. The rocker arm assembly of claim 1, wherein the recharge cam portion is rigidly coupled to the valve portion to rotate as an integral unit about a rocker shaft.

12. A method of operating a valvetrain comprising, when a cylinder deactivation mode of the valvetrain is enabled,
absorbing, by a switchable lost motion mechanism of a rocker arm assembly of the valvetrain, motion received from a drive cam by a drive cam portion of the rocker arm assembly to deactivate a cylinder associated with the valvetrain, the drive cam associated with a drive cam lift profile; and
transferring, by a recharge cam portion of the rocker arm assembly to a valve portion of the rocker arm assembly, motion received from a recharge cam by the recharge cam portion to open one or more valves associated with the cylinder to permit balancing pressure within the deactivated cylinder, the recharge cam associated with a recharge valve lift profile,
wherein the switchable lost motion mechanism is configured to selectively absorb motion from the drive cam or transfer motion from the drive cam to the valve portion.

13. The method of claim 12, further comprising, when the cylinder deactivation mode is disabled,
transferring, by the switchable lost motion mechanism, motion from the drive cam to the valve portion of the rocker arm assembly.

14. The method of claim 13, further wherein the drive valve lift profile comprises a plurality of drive valve lift displacements over an engine cycle and the recharge valve lift profile comprises a plurality of recharge valve lift displacements over the engine cycle such that each drive valve lift displacement is greater than or equal to each corresponding recharge valve lift displacement over the engine cycle.

15. The method of claim 14, further comprising, when the cylinder deactivation mode is disabled,
receiving, by the recharge cam portion, motion from the recharge cam corresponding to a base circle valve lift of the recharge cam; or
disengaging the recharge cam portion from the recharge cam for one or more portions of the engine cycle.

16. A valvetrain system comprising:
a cylinder configured to be selectively deactivated;
one or more valves associated with the cylinder;
a drive cam and a recharge cam associated with the one or more valves;
a rocker shaft;
a rocker arm assembly configured to be rotatable about the rocker shaft, the rocker arm assembly comprising:
a valve portion configured to operatively engage with the one or more valves;
a drive cam portion configured to operatively engage with a drive cam associated with a drive cam lift profile, the drive cam portion comprising a switchable lost motion mechanism configured to selectively absorb motion from the drive cam or transfer motion from the drive cam to the valve portion; and
a recharge cam portion configured to be rotatably coupled to the valve portion;
wherein when an cylinder deactivation mode is enabled,
the switchable lost motion mechanism is configured to absorb motion from the drive cam to deactivate the cylinder, and
the recharge cam portion is configured to operatively engage with a recharge cam associated with a recharge valve lift profile and transfer motion from the recharge cam to the valve portion to permit balancing pressure within the deactivated cylinder.

17. The valvetrain system of claim 16, wherein the drive valve lift profile comprises a plurality of drive valve lift displacements over an engine cycle and the recharge valve lift profile comprises a plurality of recharge valve lift displacements over the engine cycle such that each drive valve lift displacement is greater than or equal to each corresponding recharge valve lift displacement over the engine cycle.

18. The valvetrain system of claim 17, wherein when the cylinder deactivation mode is disabled, the switchable lost motion mechanism transfers motion from the drive cam to the valve portion.

19. The valvetrain system of claim 18, wherein when the cylinder deactivation mode is disabled, the recharge cam portion receives motion from the recharge cam corresponding to a base circle valve lift of the recharge cam or the recharge cam portion disengages from the recharge cam for one or more portions of the engine cycle.

20. The valvetrain system as in any of claims 16, wherein the switchable lost motion mechanism comprises a latch mechanism comprising a latch bore and one or more latch pins, the valvetrain system further comprising a lost motion spring.
